(19) United States
(12) Patent Application Publication
(10) Pub. No.: US 2009/0015751 A1
(43) Pub. Date: Jan. 15, 2009

(54) Liquid Crystal Display Device and Mobile Station Having the Same

(75) Inventors: Sung Ho Kim, Kyounggi-do (KR); Hyun Ha Hwang, Seoul (KR)

Correspondence Address: BIRCH STEWART KOLASCH & BIRCH, PO BOX 747, FALLS CHURCH, VA, 22040-0747, US

(73) Assignee: LG INNOTEK CO., LTD., Seoul (KR)

(21) Appl. No.: 10/582,248

(22) PCT Filed: Dec. 19, 2005
(86) PCT No.: PCT/KR05/04369

§ 371 Date: Jun. 9, 2006

(30) Foreign Application Priority Data
Dec. 28, 2004 (KR) 10-2004-0113972

(51) Int. Cl. G02F 1/13357

(52) U.S. Cl. 349/63

(57) ABSTRACT

A liquid crystal display device includes a transflective liquid crystal panel, a front light unit for supplying a light for displaying an image, and a micro lens sheet for receiving the light incident from the front light unit, and condensing the incident light on the transflective liquid crystal panel.

In addition, a mobile communication terminal includes a liquid crystal display device having a transflective liquid crystal panel, a front light unit for supplying a light to display an image, and a micro lens sheet for receiving the light incident from the front light unit, and condensing the incident light on the transflective liquid crystal panel, a communication unit for communicating with an exterior, and a control unit for controlling the communication unit and the liquid crystal display device.

### TECHNICAL FIELD

The present invention is related to a liquid crystal display device (LCD) and a mobile communication terminal having the same.

### BACKGROUND ART

Among display devices for displaying image information on a screen, a Braun tube display device (or, cathode ray tube (CRT)) has been most popularly used up to date. However, the CRT has several disadvantages that it is bulky and heavy in comparison with its display area.

Accordingly, a thin film type flat panel display device, which can be easily used anywhere because of its slimness, has been developed, and is gradually substituting the Braun tube display device. In particular, a liquid crystal display device (LCD) has an excellent resolution than other flat panel display devices, and the response time of the LCD device has become almost as fast as the Braun tube display device, when displaying moving pictures.

The principles of the optical anisotropy and polarization of liquid crystals are employed in driving such a LCD device. Because liquid crystal has an elongate structure, it has a direction and a polarizability of a molecule array. The direction of the molecule array can be controlled by artificially applying an electric field to the liquid crystal. When the alignment direction is controlled by such an electric field, a light is transmitted or blocked according to the alignment direction of the liquid crystal molecules due to the optical anisotropy of the liquid crystal, thereby displaying colors and images.

In an active matrix LCD, an active device with a nonlinear characteristic is added into each of pixels arranged in a shape of matrix. Thus, an operation of each pixel is controlled using a switching characteristic of this device.

Meanwhile, in recently, various researches for a dual display have been undertaken, which is capable of displaying an image in both front and rear of LCD.

### DISCLOSURE

### Technical Problem

The present invention is to provide a liquid crystal display device (LCD) capable of displaying an image in both front and rear of a liquid crystal panel using one transflective liquid crystal panel.

Also, the present invention is to provide a mobile communication terminal capable of displaying an image in both sides of liquid crystal panel, using the LCD in which one transflective liquid crystal panel is employed.

### Technical Solution

In an aspect of the present invention, there is provided a liquid crystal display device including: a transflective liquid crystal panel; a front light unit for supplying a light for displaying an image; and a micro lens sheet for receiving the light incident from the front light unit, and condensing the incident light on the transflective liquid crystal panel.

In another aspect of the present invention, there is provided a mobile communication terminal including: a liquid crystal display device including a transflective liquid crystal panel, a front light unit for supplying a light for displaying an image, and a micro lens sheet for receiving the light incident from the front light unit, and condensing the incident light on the transflective liquid crystal panel; a communication unit for communicating with an exterior; and a control unit for controlling the communication unit and the liquid crystal display device.

### ADVANTAGEOUS EFFECTS

According to the LCD of the present invention, there is an advantage that it can display an image in both front and rear of a liquid crystal panel using one liquid crystal panel.

Also, according to the mobile communication terminal of the present invention, there is another advantage of providing a slim mobile communication terminal capable of displaying an image on both surfaces of a liquid crystal panel, using the LCD in which one liquid crystal panel is employed. For example, according to the present invention, when fabricating a liquid crystal display module for displaying the image on both surfaces, it may be fabricated in 3.5 mm thick or less.

### DESCRIPTION OF DRAWINGS

FIG. 1 is a schematic view illustrating a constitution of a liquid crystal display device (LCD) according to the present invention;

FIG. 2 is a drawing illustrating an image display using a light supplied from a front light unit, in the LCD according to the present invention; and

FIG. 3 is a drawing illustrating an image display using an external light source in the LCD according to the present invention.

### MODE FOR INVENTION

Reference will now be made in detail to the preferred embodiments of the present invention, examples of which are illustrated in the accompanying drawings.

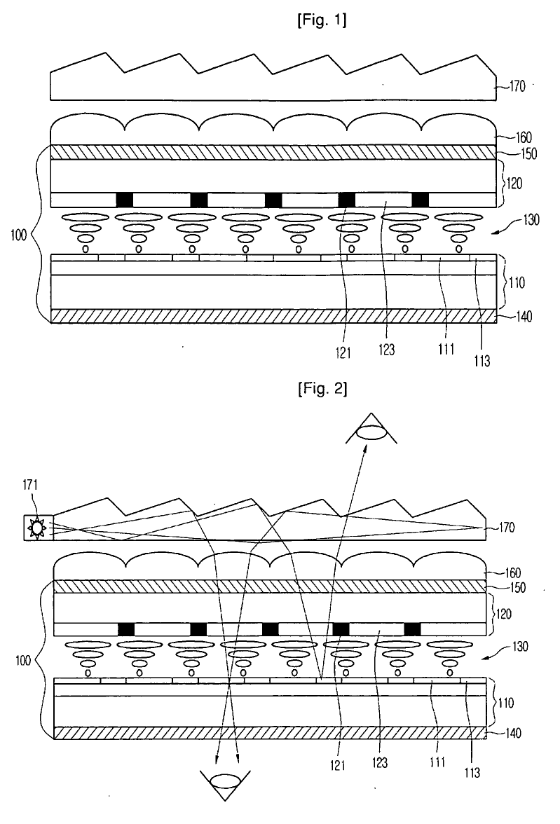

FIG. 1 is a schematic view illustrating a constitution of a liquid crystal display device (LCD) according to the present invention. The LCD according to the present invention, as illustrated in FIG. 1, includes a transflective liquid crystal panel 100, a front light unit 170 for supplying a light for image display, and a micro lens sheet 160 for receiving the light incident from the front light unit 170 and condensing the incident light on the transflective liquid crystal panel 100.

Since the front light unit 170 is disposed in front of the transflective liquid crystal panel 100 in the LCD according to the present invention, it is possible to display an image in both front and rear of the transflective liquid crystal panel 100.

That is, the LCD of the present invention provides a first display mode for displaying an image in front of the transflective liquid crystal panel 100 using the light reflected from a reflective plate 113 of the transflective liquid crystal panel 100. In addition, the LCD of the present invention provides a second display mode for displaying an image in rear of the transflective liquid crystal panel 100 using the light transmitted through a transmissive electrode 111 of the transflective liquid crystal panel 100.

Furthermore, the LCD of the present invention includes the micro lens sheet 160 on the transflective liquid crystal panel 100.

The micro lens sheet 160 plays roles in receiving the light incident from the front light unit 170, and condensing the incident light on an opening of a pixel region constituting the transflective liquid crystal panel 100. The micro lens sheet 160, which is a transparent film having a microstructure in pixel units, acts as a micro lens array.

Herein, the opening represents a region where a black matrix 121 is not formed in a second substrate 120 of the transflective liquid crystal panel 100. At a region of a first substrate 110 corresponding to the opening, there are provided the transmissive electrode 111 and the reflective plate 113. Accordingly, the light condensed on the region where the transmissive electrode 111 is formed makes an image be displayed in rear of the transflective liquid crystal panel 100. In addition, the light condensed on the region where the reflective plate 113 is formed is reflected so as to make the image be displayed in front of the transflective liquid crystal panel 100.

The transmissive electrode 111 and the reflective plate 113 are formed at every pixel which is a minimum unit for implementing a picture. The transmissive electrode 111 receives a voltage by a switching device, which is, for example, a thin film transistor to control a turn-on/off state. The reflective plate 113 may act as an electrode for receiving a voltage. Alternatively, the reflective plate 113 may be used as a reflective surface without applying the voltage separately.

According to the present invention, because the micro lens sheet 160 is disposed on the transflective liquid crystal panel 100, whole the lights incident on the transflective liquid crystal panel 100 are condensed on each opening region. Thus, according to the present invention, the incident light can be effectively utilized in comparison with the related art transflective liquid crystal panel, which results in improving a luminance of an image. That is, according to the present invention, it is not necessary to increase the number of a light source included in the front light unit 170 or increase the power applied to the light source. Therefore, it is possible to improve the luminance without increasing power consumption.

Furthermore, the micro lens sheet 160 also serves a role of condensing the light incident from an external light source on the opening of the transflective liquid crystal panel 100 by the same principle.

The micro lens sheet 160 may be formed in a shape of a stripe type lenticular lens or a cylindrical lens.

In addition, the micro lens sheet 160 may be configured such that a lens shape is formed at a location corresponding to each unit pixel of the transflective liquid crystal panel 100. In case of employing the micro lens sheet 160 having the lens shape for every pixel, each unit lens is aligned such that the location of each unit lens should be correspondent to each pixel. Accordingly, when attaching each lens on a second polarizer 150, it is required higher alignment accuracy during the fabrication process in comparison with other examples. Herein, each unit lens included in the micro lens sheet 160 may be formed in a shape of a spherical lens or aspheric lens. In addition, each unit lens may be formed in a shape of a decentered lens.

Meanwhile, the transflective liquid crystal panel 100 is configured with a first substrate 110, a second substrate 120, a liquid crystal layer 130, a first polarizer 140, and a second polarizer 150. Since detail illustrations for these elements are well known already, explanations will be schematically described herein.

The first substrate 110 is provided with an array device having a thin film transistor, the transmissive electrode 111 formed on the array device for displaying an image by transmitting the incident light, an insulating layer formed on the transmissive electrode 111, and the reflective plate 113 formed on a predetermined portion of the insulating layer, for displaying an image by reflecting the incident light.

Herein, as one of examples, it is illustrated that the reflective plate 113 is formed on the transmissive electrode 111. However, the transmissive electrode 111 and the reflective plate 113 may be alternately formed on the array device. Various methods for arranging and forming the transmissive electrode 111 and the reflective plate 113 are also well known, which is not a main concern of the present invention so that further descriptions will be omitted herein.

The array device is configured with a plurality of gate lines formed in a first direction, a plurality of data lines formed perpendicular to the gate lines, a pixel region defined by the gate line and the data line, and a thin film transistor formed at a region where the gate line and the data line are intersected with each other.

In addition, the second substrate 120 is disposed opposite to the first substrate 110. The second substrate 120 is configured with a color filter 123 formed at a location corresponding to the region where the transmissive electrode 111 of the first substrate 110 is formed, a black matrix 121 formed between the color filters 123, and a common electrode (not shown) formed under the color filter 123.

Between the first and second substrates 110 and 120, the liquid crystal layer 130 is filled. The first polarizer 140 is disposed under the first substrate 110, and the second polarizer 150 is disposed on the second substrate 120.

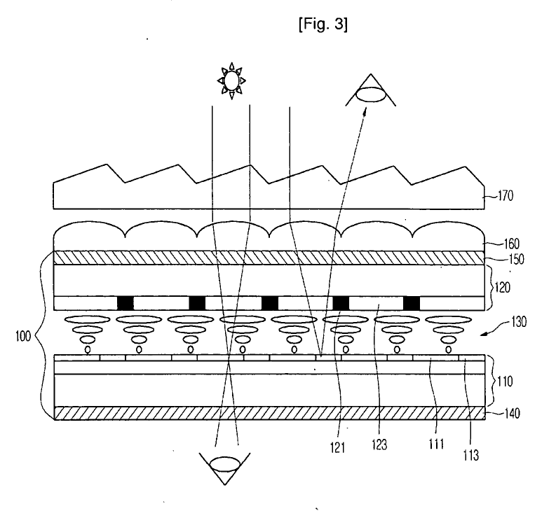

In the LCD having the above structure, a procedure of displaying an image will be set forth with reference to FIGS. 2 and 3. FIG. 2 is a drawing illustrating an image display using the light supplied from the front light unit in the LCD according to the present invention, and FIG. 3 is a drawing illustrating an image display using an external light source in the LCD according to the present invention.

To begin with, referring to FIG. 2, the procedure of displaying the image using the light supplied from the front light unit will be illustrated.

The LCD according to the present invention can display the image in both front and rear of the transflective liquid crystal panel 100 using the light supplied from a light source 171 of the front light unit 170.

The front light unit 170 has the light source 171 on a side surface thereof, and the light source 171 may be configured as a light emitting diode (LED). Herein, the LED may be configured as a white LED, or a red LED/green LED/blue LED.

Also, the light source 171 may be configured as a cold cathode fluorescent lamp (CCFL) or an external electrode fluorescent lamp (EEFL).

The LCD of the present invention, as illustrated in FIG. 3, can display the image in both front and rear of the transflective liquid crystal panel 100 using the light supplied from the external light source such as the sun or a lighting apparatus. That is, in case that the front light unit 170 is in off-state, it is possible to display the image on both surfaces of the transflective liquid crystal panel 100 using the light incident from the external light source. At this time, peripheral lights are condensed on the opening of the transflective liquid crystal panel by means of the micro lens sheet 160. Therefore, it is possible to increase the luminance of the image much higher.

Meanwhile, the LCD having the above structure may be utilized as a dual display device. Accordingly, if applying the inventive LCD to the mobile communication terminal such as a portable terminal, a personal digital assistant (PDA) or the like, the image can be displayed in both front and rear of the liquid crystal panel. Therefore, it is possible to implement various image display functions in the mobile communication terminal.

For example, in case that the inventive LCD is applied to the mobile communication terminal having the function of a digital camera, there is availability that a few of users can see the same pictures of the same size and the same resolution on both surfaces of the mobile communication terminal.

### INDUSTRIAL APPLICABILITY

According to the LCD of the present invention, there is an advantage that it can display an image in both front and rear of a liquid crystal panel using one liquid crystal panel.

Also, according to the mobile communication terminal of the present invention, there is another advantage of providing a slim mobile communication terminal capable of displaying an image on both surfaces of a liquid crystal panel, using the LCD in which one liquid crystal panel is employed. For example, according to the present invention, when fabricating a liquid crystal display module for displaying an image on both surfaces thereof, it may be fabricated in 3.5 mm thick or less.

1. A liquid crystal display device comprising:
a transflective liquid crystal panel;
a front light unit for supplying a light for displaying an image; and
a micro lens sheet for receiving the light incident from the front light unit, and condensing the incident light on the transflective liquid crystal panel.

2. The liquid crystal display device according to claim 1, wherein the image is displayed in both front and rear of the transflective liquid crystal by first and second display modes, respectively, the first display mode allowing the image to be displayed in front of the transflective liquid crystal panel using the light reflected by a reflective region of the transflective liquid crystal panel, the second display mode allowing the image to be displayed in rear of the transflective liquid crystal panel using the light transmitted through a transmissive region of the transflective liquid crystal.

3. The liquid crystal display device according to claim 1, wherein the front light unit includes a light source on a side surface thereof.

4. The liquid crystal display device according to claim 3, wherein the light source is selected from the group including a light emitting diode (LED), a cold cathode fluorescent lamp (CCFL), and an external electrode fluorescent lamp (EEFL).

5. The liquid crystal display device according to claim 3, wherein the light source is configured with a white light emitting diode (LED).

6. The liquid crystal display device according to claim 3, wherein the light source is configured with a red LED, a green LED, and a blue LED.

7. The liquid crystal display device according to claim 1, wherein the transflective liquid crystal panel comprises:
a first substrate including an array device having a thin film transistor, a transmissive electrode formed on the array device for displaying the image by transmitting the incident light, and a reflective plate for displaying the image by reflecting the incident light;
a second substrate disposed on a position which is opposite to the first substrate, wherein the second substrate includes a color filter formed on a location corresponding to a region where the transmissive electrode of the first substrate is formed, and a black matrix formed between the color filters; and
a liquid crystal panel filled between the first substrate and the second substrate.

8. The liquid crystal display device according to claim 7, wherein the array device comprises:
a plurality of gate lines formed in a first direction;
a plurality of data lines formed perpendicular to the gate lines;
a pixel region defined by the gate line and the data line; and
a thin film transistor formed at a region where the gate line and the data line are intersected with each other.

9. The liquid crystal display device according to claim 7, further comprising an insulating layer formed on the transmissive electrode.

10. The liquid crystal display device according to claim 1, wherein the micro lens sheet condenses the light incident from the light source on an opening of the transflective liquid crystal panel, and the opening is a region where the black matrix of the transflective liquid crystal panel is not formed.

11. The liquid crystal display device according to claim 1, wherein the micro lens sheet is formed in a shape of a lenticular lens or a cylindrical lens.

12. The liquid crystal display device according to claim 7, further comprising a common electrode under the color filter.

13. The liquid crystal display device according to claim 1, wherein the micro lens sheet is formed such that a lens shape is formed at a location corresponding to each unit pixel of the transflective liquid crystal panel.

14. The liquid crystal display device according to claim 13, wherein the lens shape is formed in a predetermined shape selected from the group including a spherical lens shape, an aspheric lens shape or a decentered lens shape.

15. A mobile communication terminal comprising:
a liquid crystal display device including a transflective liquid crystal panel, a front light unit for supplying a light for displaying an image, and a micro lens sheet for receiving the light incident from the front light unit, and condensing the incident light on the transflective liquid crystal panel;
a communication unit for communicating with an exterior; and
a control unit for controlling the communication unit and the liquid crystal display device.

16. The mobile communication terminal according to claim 15, wherein the image is displayed in both front and rear of the liquid crystal display device by first and second display modes, respectively, the first display mode allowing the image to be displayed in front of the liquid crystal display device using the light reflected by a reflective region of the transflective liquid crystal panel, the second display mode allowing the image to be displayed in rear of the liquid crystal display device using the light transmitted through a transmissive region of the transflective liquid crystal.

17. The mobile communication terminal according to claim 15, wherein the micro lens sheet condenses the light incident from the light source on an opening of the transflective liquid crystal panel, and the opening is a region where the black matrix of the transflective liquid crystal panel is not formed.

18. The mobile communication terminal according to claim 15, wherein the micro lens sheet is formed in a shape of a lenticular lens or a cylindrical lens.

19. The mobile communication terminal according to claim 15, wherein the micro lens sheet is formed such that a lens shape is formed at a location corresponding to each unit pixel of the transflective liquid crystal panel.

20. The mobile communication terminal according to claim 19, wherein the lens shape is formed in a predetermined shape selected from the group including a spherical lens shape, an aspheric lens shape or a decentered lens shape.
